(19) United States
(12) Patent Application Publication
(10) Pub. No.: US 2011/0176855 A1
(43) Pub. Date: Jul. 21, 2011

(54) WRITING IMPLEMENT (EMBODIMENTS)

(76) Inventor: Murtaza Magomedgabibovich Tabiev, Izberbash (RU)

(21) Appl. No.: 13/120,909

(22) PCT Filed: Sep. 23, 2009
(86) PCT No.: PCT/RU2009/000489

§ 371 Date: Mar. 24, 2011

(30) Foreign Application Priority Data
Sep. 26, 2008 (RU) 2008138228

(51) Int. Cl. B43K 23/00

(52) U.S. Cl. 401/143

(57) ABSTRACT

The invention (embodiments) is intended to increase the functional characteristics of a writing implement and allow for the improved visual monitoring of writing. This is achieved in that the writing implement comprises a holder, a body with a writing unit located therein and having a rod-type writing element, and a stem part, wherein the holder of the rod-type writing element is formed from sections having an arcuate form, wherein the sections are separated from each other in steps and have different lengths and angles of inclination to the horizontal, and the rod-type writing element is mounted in inclined fashion and is offset from the axis of the implement. The technical result is also achieved in that the writing implement comprises a holder, a body with a writing unit located therein and having a rod-type writing element, and a stem part, wherein the holder of the working component has an arcuate form, and the working component is mounted in inclined fashion and is offset from the axis of the implement.

### FIELD OF THE INVENTION

This utility model (embodiments) relates to the manufacture of stationery goods.

### BACKGROUND OF THE INVENTION

A prior art pen that is the closest prior art of the claimed embodiments comprises a barrel containing a writing unit with a cartridge writing element (Patent RU 2,019,420 C1, Sep. 15, 1994).

The prior art pen is disadvantageous because of its inadequate quality in use.

### SUMMARY OF THE INVENTION

The embodiments of the claimed utility model are aimed at expanding the range of pen utilities.

The technical results achieved by this utility model (embodiments) are the possibility of writing control being improved by moving the axial line of the writing element closer to the hand point of rest, superior writing quality, lower pressure applied to the pen as a result of a different angle at which the cartridge ball contacts the writing surface, and improved view of writing.

The technical result of the first embodiment is achieved by providing the writing instrument with a holder, a barrel containing a writing unit having a cartridge writing element, and a tailpiece, the holder of the cartridge writing element consisting of arcuate sections, which sections are separated stepwise from each other and having different lengths and inclination angles to the horizontal plane, and the cartridge writing element extending at an angle and being offset relative to the axis of the writing instrument.

The technical result of the second embodiment is also achieved the providing the writing instrument with a holder, a barrel containing a writing unit with a cartridge writing element, and a tailpiece, the holder of the cartridge writing element having an arcuate shape, and the cartridge writing element extending at an angle and being offset relative to the axis of the writing instrument.

### BRIEF DESCRIPTION OF THE DRAWINGS

FIG. 1 is a side view of the first embodiment of the writing instrument.

FIG. 2 is a top view of the first embodiment of the writing instrument.

FIG. 3 is a front view of the first embodiment of the writing instrument.

FIG. 4 is a side view of the second embodiment of the writing instrument.

FIG. 5 is a top view of the second embodiment of the writing instrument.

FIG. 6 is a front view of the second embodiment of the writing instrument.

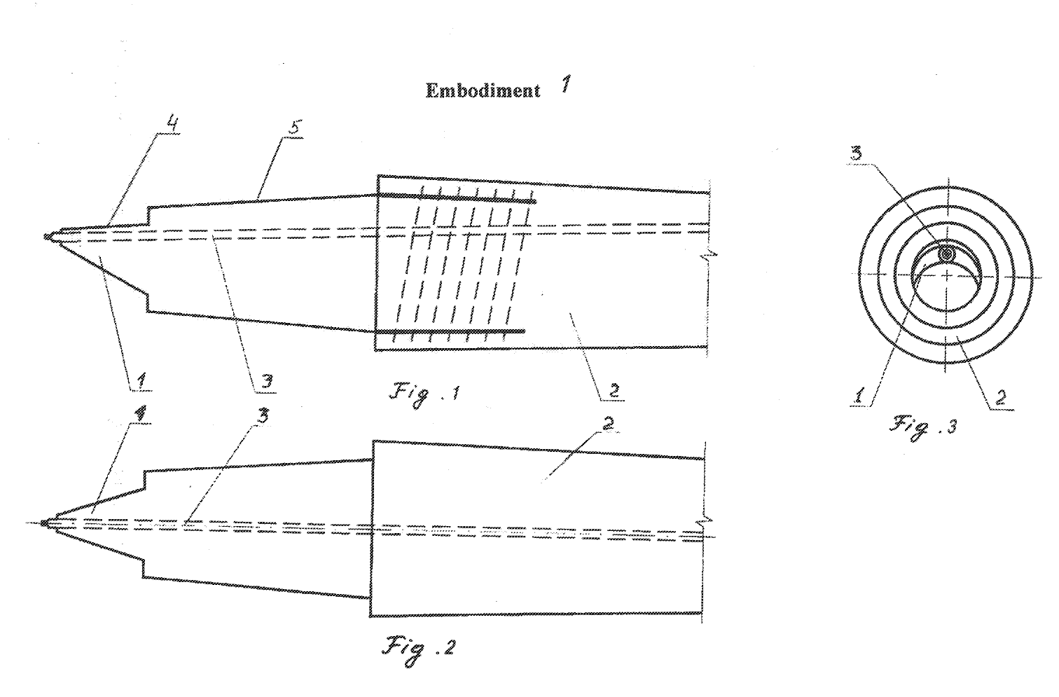

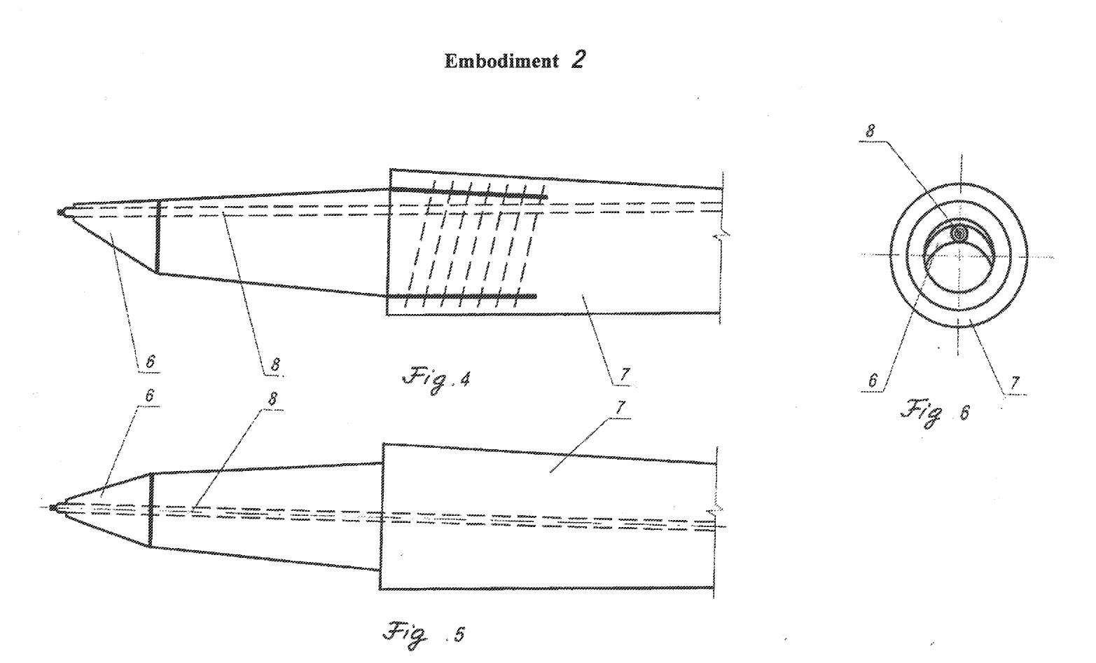

### DESCRIPTION OF THE EMBODIMENTS OF THE UTILITY MODEL

The writing instrument (first embodiment) comprises a holder 1, a barrel 2 containing a writing unit (not shown) having a cartridge writing element 3, and a tailpiece (not shown), holder 1 of writing element 3 consisting of sections 4 and 5 of arcuate shape, said sections being separated stepwise from each other and having different lengths and inclination angles to the horizontal plane, and cartridge writing element 3 being inclined and offset relative to the axis of the writing instrument.

The writing instrument (second embodiment) comprises a holder 6, a barrel 7 containing a writing unit (not shown) having a cartridge writing element 8 and a tailpiece (not shown), holder 6 of writing element 8 having an arcuate shape, and cartridge writing element 8 extending at an angle and offset relative to the axis of the writing instrument.

The writing instrument is used as follows:

Upon contact with the writing plane, the writing instrument occupies, because of its design, the most convenient position for writing to be watched because writing element 3 is in a securely fixed position convenient for the writer's hand. This position helps reduce the pressure applied by the hand and improve the view of writing.

### INDUSTRIAL APPLICABILITY

The utility model can be used in ballpoint pens, automatic pencils, and in soft-tip pens for writing and drawing.

What is claimed is:

1. A writing instrument comprising a holder, a barrel containing a writing unit with a cartridge writing element, and a tailpiece, the holder of the cartridge writing element consisting of sections of arcuate shape, said sections being separated stepwise from each other and having different lengths and inclination angles to the horizontal plane, and the cartridge writing element being inclined and offset relative to the axis of the writing instrument.

2. A writing instrument comprising a holder, a barrel containing a writing unit with a cartridge writing element, and a tailpiece, the holder of the cartridge writing element having an arcuate shape and the cartridge writing element being inclined and offset relative to the axis of the writing instrument.
